(19) United States
(12) Patent Application Publication
(10) Pub. No.: US 2016/0017151 A1
(43) Pub. Date: Jan. 21, 2016

(54) NOVEL ROAD MARKINGS FOR ASSISTING THE PERCEPTION OF THE SURROUNDINGS OF VEHICLES

(71) Applicants: Guido PROTZMANN, (US); Jörn KIWITT, (US); Dominik KIEFER, (US); Günter SCHMITT, (US); Marita KAUFMANN, (US); Michael OLAPOJU, (US)

(72) Inventors: Guido PROTZMANN, Bensheim (DE); Joern KIWITT, Muenster (DE); Dominik KIEFER, Pfinztal (DE); Guenter SCHMITT, Darmstadt (DE); Marita KAUFMANN, Griescheim (DE); Michael OLAPOJU, Wiesbaden (DE)

(73) Assignee: EVONIK ROEHM GMBH, Darmstadt (DE)

(21) Appl. No.: 14/774,054

(22) PCT Filed: Mar. 13, 2014
(86) PCT No.: PCT/EP2014/054975

§ 371 Date: Sep. 9, 2015

(30) Foreign Application Priority Data
Apr. 8, 2013 (DE) 10 2013 206 116.8

(51) Int. Cl. C09D 5/33; C09J 7/00; C09J 11/04; C09D 7/12

(52) U.S. Cl. CPC C09D 5/004; C09D 7/1291; C09D 7/1216; C09J 7/00; C09J 11/04; C08K 7/00

(57) ABSTRACT

The present invention encompasses an innovative concept for the marking of trafficways, more particularly roads. The application qualities and lifetime of these new markings are comparable with those of the prior art. The markings also possess properties comparable with those of the prior art in respect of night visibility, back-in-service time, and surface quality. An additional contribution of the markings of the present invention, however, is that they can be used to support modern driver assistance systems and autonomous driving. With this in mind, the present invention relates more particularly to road markings which, building on established systems, are equipped with additional reflection capacity for electromagnetic radiation, more particular for microwaves and/or infrared radiation.

### FIELD OF THE INVENTION

The present invention encompasses an innovative concept for the marking of trafficways, more particularly roads. The application qualities and lifetime of these new markings are comparable with those of the prior art. The markings also possess properties comparable with those of the prior art in respect of night visibility, back-in-service time, and surface quality. An additional contribution of the markings of the present invention, however, is that they can be used to support driver assistance systems and autonomous vehicles. With this in mind, the present invention relates more particularly to road markings which, building on established systems, are equipped with additional reflection capacity for electromagnetic radiation, more particular for microwaves and/or infrared radiation.

### PRIOR ART

Driver assistance systems (DAS) have already been under the spotlight in automobile development for some considerable time. The systems raise levels of driving comfort and traffic safety. Examples of current systems include adaptive cruise control, emergency braking assistants, parking aids and lane-change assistants. Customarily, radar sensors, infrared sensors, lidar sensors, camera sensors and/or ultrasound sensors are used for the peripheral perception.

Many driver assistance systems, such as lane departure warning systems, for example, require reliable information concerning the trafficway, such as lane width, number of lanes and road course, for instance. Moreover, the vehicle position relative to the trafficway must be known. The reliable capture of this data is especially important in relation in particular to the future vision of Autonomous Driving.

The information concerning the static environment of the vehicle may take the form of a stored map. All that is required is to undertake positioning within the map. Location may be carried out, for example, using a global navigation satellite system (GNSS) such as GPS or Galileo. A disadvantage here is that the location accuracy is not sufficient to guarantee reliable operation of driver assistance systems and autonomous vehicles. More precise location can be obtained using a local, radio-based or optical location system along the trafficway. The construction of this infrastructure, however, is costly and involved.

In the case of the method with a stored map, an additional drawback is that the map must correspond precisely to reality. This cannot be guaranteed, in light of temporary disruptions or changes to the course of the trafficway, such as construction sites, for example.

For the reasons given, it is essential, for DAS and autonomous vehicles, for precise information concerning the trafficway/lane and the vehicles' own position relative thereto to be reliably determined during driving.

At the present time, this function is fulfilled almost exclusively using video cameras, which are usually mounted behind the windscreen, on the rear view mirror. The traffic lanes are detected in the video image by means of digital image processing. These traffic lanes are recognized primarily from the trafficway markings.

The systems are unable, however, to recognize the traffic lanes reliably in every situation. Problems occur in construction sites if temporary trafficway markings are being employed. The optical measurement method also reaches limits in adverse weather conditions such as fog, rain and snow. Difficulties are also encountered when the sun is low and therefore blinding. When there is a lack of contrast between trafficway markings and trafficway topping, and also in the case of trafficway markings that have eroded or are simply absent, the traffic lane in some cases cannot be recognized at all. Furthermore, tar joins on the trafficway can lead to misinterpretations in lane recognition.

For the reasons given, the need exists to allow trafficway markings to be recognized more reliably by driver assistance systems and autonomous vehicles. To date there has been no description in the prior art of trafficway markings adapted to the requirements of automotive systems for peripheral perception.

There are a variety of kinds of road markings.

Currently in use as trafficway marking materials are systems such as solvent-based paints, water-based paints, thermoplastic paints, paints based on reactive resins, or cold plastics, and prefabricated adhesive tapes. A disadvantage of the latter is that they are costly and involved in their production and their application. Also, with a view to a desired long life for the marking, there are only limited degrees of freedom concerning the design of the marking, with glass beads, for example.

Solvent-based paints are a very old art and have the particular disadvantage that they cannot, for example, be equipped with glass beads in order to enhance light reflection.

Marking films, especially those with glass beads on the surface for the purpose of enhancing night visibility, are described in WO 99/04099 and WO 99/04097, for example. Also disclosed in these specifications is a corresponding process for producing the marking films and for equipping these films with glass beads.

Road markings based on reactive resin are found for example in patent applications EP 2 054 453, EP 2 454 331, EP 2 528 967, WO 2012/100879 and WO 2012/146438.

Aqueous marking systems are described for example in EP 2 077 305, EP 1 162 237 and U.S. Pat. No. 4,487,964.

### Object

It is an object of the present invention to provide a new concept for road marking that makes a contribution to peripheral perception by vehicles and at the same time effectively reflects in particular microwaves and/or infrared radiation.

A further object of the present invention is that this road marking should be easy to apply and should have a long lifetime.

A particular object is that these innovative road markings can be made available by modification of established systems and hence can be laid or applied with existing techniques, without additional conversion of the corresponding machines.

Other objects, not explicitly stated, will become apparent from the overall context of the following description, claims and examples.

### Solution

The objects are achieved by an innovative, radiation-reflecting road marking which comprises spherical metal particles and/or cylindrical metal particles, each with specific dimensions. Here, the spherical metal particles employed according to the invention have a diameter d of between x*0.7*λ/π and x*1.3*λ/π, preferably of between x*0.9*λ/π and x*1.1*λ/π. Here, λ is the wavelength of the radiation to be reflected. Also, x is an integer between 1 and 6, preferably between 1 and 4 and particularly preferably 1. Depending on the wavelength radiated thereon, these diameters constitute the regions of maximum Mie scattering.

According to the invention, “spherical” means that, in the ideal case, the particles are almost perfect spheres. However, according to the invention, spherical is also understood to mean spherical particles which are not perfect, but only approximately perfect. Such particles at most have a ratio of 1.5, preferably 1.3, between the thickest diameter to be measured of the particle and the thinnest diameter to be measured thereof. Here, these diameters always pass through the geometric centre of gravity of the particle.

According to the invention, it is alternatively or additionally possible for a second type of metal particle, which are cylindrical metal particles, to be employed. In respect of the scattering and reflection behaviour thereof, these cylindrical metal particles are also referred to as dipole antennas. These metal particles have a length/width ratio of between 2 and 100, preferably of between 4 and 50 and particularly preferably of between 5 and 20. Furthermore, these particles have a length l of between y*λ/1.8 and y*λ/3, preferably of between y*λ/1.9 and y*λ/2.2. Here, y is an integer between 1 and 20, preferably between 1 and 4 and particularly preferably 1.

Here, the cylindrical metal particles also comprise metal particles which consist of two or more above-described cylindrical metal particles that are connected to one another.

In order to obtain optimum resonance with the electromagnetic radiation, the orientation of the small dipole antennas in or on the road marking should be matched to the polarization of the radar waves. This means that these particles are ideally placed onto the road marking aligned perpendicular to the drive direction. However, as a result of this, the marking can no longer be detected from all directions. Depending on the application, this can even constitute an advantage.

By contrast, an alignment is not necessary in the case of spherical particles.

In automotive driver assistance systems, radar sensors are used in Europe with, in particular, the following frequency bands: between 24 and 24.25 GHz, between 21.65 and 26.65 GHz, between 76 and 77 GHz, between 77 and 81 GHz and, in future, very probably at around 122 GHz. The widely used frequency bands between 76 and 77 GHz and between 77 and 81 GHz are of particular interest here.

The frequency band at approximately 122 GHz achieves a higher angular resolution, but stronger attenuation in the far-field region. It is for this reason that this frequency band will probably be used primarily for detection in the automotive near field.

Bands between 46.7 and 46.9 GHz and between 60 and 61 GHz are also used for automotive radar sensors in the USA and Japan, respectively.

In particular, the metal particles in the road markings according to the invention are selected for electromagnetic radiation with a frequency of between 20 and 130 GHz, preferably between 76 and 81 GHz, to be reflected. Here, in accordance with the specifications listed above, the particle size is calculated from the wavelength, which emerges directly from the frequency of the employed electromagnetic radiation. Here, λ=c/f, where f is the frequency and c is the propagation speed which, in the case of electromagnetic radiation, is the speed of light.

Hence, for example, the following exemplary particle sizes emerge for spherical metal particles with a factor x=1:
a) For the frequency band between 24 and 24.25 GHz, and hence a mean frequency f=24.125 GHz or λ=12.4 mm, this results in an ideal diameter d of 3.95 mm.
b) For the frequency band between 76 and 77 GHz, and hence a mean frequency f=76.5 GHz or λ=3.92 mm, this results in an ideal diameter d of 1.25 mm.
c) For the frequency band between 77 and 81 GHz, and hence a mean frequency f=79 GHz or λ=3.8 mm, this results in an ideal diameter d of 1.21 mm.
d) For f=122 GHz or λ=2.46 mm, this results in an ideal diameter d of 0.78 mm.

Hence, for example, the following exemplary particle lengths emerge for cylindrical metal particles with a factor y=1:
a) For the frequency band between 24 and 24.25 GHz, and hence a mean frequency f=24.125 GHz or λ=12.4 mm, this results in an ideal length l of 6.20 mm.
b) For the frequency band between 76 and 77 GHz, and hence a mean frequency f=76.5 GHz or λ=3.92 mm, this results in an ideal length l of 1.96 mm.
c) For the frequency band between 77 and 81 GHz, and hence a mean frequency f=79 GHz or λ=3.8 mm, this results in an ideal length l of 1.90 mm.
d) For f=122 GHz or λ=2.46 mm, this results in an ideal length l of 1.23 mm.

These metal particles reflect electromagnetic radiation given off, for example, by a corresponding device on a vehicle. At the same time the vehicle may be equipped with a corresponding detector that detects the reflected radiation. In this way information to control the vehicle can be read off directly on the road surface, from the road marking.

The metal particles are more preferably particles which consist wholly or partly of aluminium, iron, zinc or magnesium or of an alloy predominantly comprising aluminium, iron or zinc. Especially preferred particles are those which consist wholly or partly of aluminium or iron. Different materials, however, may also be combined with one another. This can be done, for example, through the use of more than one kind of metal particle.

In the simplest embodiment of the invention the metal particles are solid metal particles—i.e. particles which consist wholly of the metal. The invention, though, is not confined to particles of this kind. Thus it also possible for hollow metallic beads to be employed. Moreover, the surface of the particle may have a coating of the metal, beneath which there is a different material such as glass or a plastic, for example. One particular embodiment of the invention embraces metal, very preferably in bead form, coated with glass, PMMA or polycarbonate. Particles of this latter embodiment not only contribute to reflection of the stated electromagnetic radiation—that is, more particularly, of microwaves and/or infrared radiation—but also, in addition, reflect visible light very well. As a result, if the particles are present on the surface of the road marking, it is also possible, additionally, to ensure reflection of visible light. The latter is particularly significant at night and to date, in accordance with the prior art, has been achieved predominantly by means of pure glass beads.

The particles may simply be embedded into the matrix material of the road marking. Even if the metal particles are completely enclosed by this matrix material, the reflection of microwaves, for example, is still possible.

Alternatively the metal particles are situated on the surface of the road marking. Particularly in such an embodiment—but also with complete embedding as well—it is preferred if, additionally, adhesion promoters are used in order to improve the adhesion of the metal particles to the material of the road marking.

To this end there are two alternative embodiments. In the first, the metal particles are provided on the surface with an adhesion promoter. In the second embodiment, the matrix material of the road marking comprises the adhesion promoter.

Suitable adhesion promoters encompass a range of substances. In each specific case, the choice of adhesion promoter by the skilled person is made on the basis, in particular, of the choice of the matrix material and of the metal used. Examples of such adhesion promoters are silanes, hydroxy esters, amino esters, urethanes, isocyanates and/or acids that are copolymerizable with (meth)acrylates. In the case of the silanes, the system in question may, for example, involve silanization of the—oxidic, for example—glass or metal surface. An alternative possibility, for example, is to use an alkoxy- and/or hydroxysilylalkyl (meth)acrylate, of the kind sold by Evonik Industries AG under the name Dynasylan® MEMO, for example. One example of a hydroxy ester is hydroxyethyl methacrylate. Examples of a copolymerizable acid are itaconic acid, maleic acid, methacrylic acid, acrylic acid, β-carboxyethyl acrylate or the corresponding anhydrides. An amino ester is, for example, N-dimethylaminopropylmethacrylamide.

The chosen amount of the metal particles used can be varied to a relatively high degree. The limiting factor on the minimum amount is sufficient detection by a sensor. A sufficient minimum amount may be achieved with just a 0.1 area % coverage of the marking by metal particles. In respect in particular of the longevity of the reflection capacity, however, larger amounts are preferred. For the skilled person, guidance in this context may be taken from the amount of glass beads typically used. Similar amounts of glass beads scattered additionally onto the marking are not a disruption here. Overall, nevertheless, it should of course be ensured that the total area of glass beads and metal particles placed onto the surface is less than the area of the marking in such a way that the majority of the particles and beads achieve contact with the surface of the material. If the metal particles are incorporated into the matrix in such a way that they are fully enclosed by the matrix, care should be taken to ensure that the cohesion of the matrix is not disrupted by too large a quantity of particles.

In the case of adhesive sheets, the number of metal beads should be considered in the same way as for the lower limit. As far as the upper limit is concerned, it is entirely possible for an opaque layer of the metal particles to be formed.

The solution according to the invention, of a road marking comprising metal particles, may be based on diverse established road marking systems. The only critical factor for its implementation is that a road marking is selected in which sufficient adhesion for the metal particles is ensured. Road markings suitable in principle are those into which glass beads can be incorporated. The road markings that can be used are preferably structural markings, more particularly cold plastics, adhesive tapes or water-based paints—the latter more particularly in a structural marking configuration.

If the road marking comprises a prefabricated adhesive tape, the metal particles can be added in the same way as for the glass beads during the production of the adhesive tape. WO 99/04099, for instance, describes a technique wherein the adhesive tape is coated with a layer of adhesion promoter or with the melt of a thermoplastic and subsequently, in the same operation, glass beads are scattered onto this still-adhesive layer. This thermoplastic may also be applied in structures or local elevations, so that in this way a local accumulation of the beads or a pattern thereof is obtained. This method can also be applied simply to metal particles by analogy.

Alternatively, an adhesive layer can also be applied to the top face of the adhesive tape, and the metal particles—optionally together with the glass beads—may be applied to said layer by scattering, and subsequently cured and/or sealed with a further coating layer or film layer. It is also possible, furthermore, for the metal particles to be scattered between the two layers in a coextrusion or laminating operation as part of the production of a multi-layer film. Additionally possible, especially in the case of very small metal particles, is the direct coextrusion of the metal particles as part of the adhesive tape production process.

An equally useful alternative to adhesive tapes is represented by structural markings which are applied directly to the trafficway surface. In this case there are two important variants. In one case, the road marking may be a water-based paint. Alternatively, it may be a cold plastic. The latter is obtained by the application and curing of a reactive resin, which is usually a filled resin. In theory, solvent-based systems are also conceivable. In the structural markings sector, however, such systems are relatively insignificant.

Irrespective of which structural marking technology is involved, the metal particles may be incorporated into the marking in similar ways. Both systems, generally, are two-part systems whose components are mixed with one another shortly prior to application. It is also possible for the metal particles to be incorporated by stirring in the same method step. Alternatively the metal particles may also be present in one of the components beforehand. With this approach, road markings are obtained in which the metal particles are predominantly included in the matrix.

It is also possible, however, for the metal particles to be scattered on during or directly after the application of the aqueous coating material or of the cold plastic. In this case a road marking is obtained which has the metal particles predominantly on the surface. Where glass beads are also applied, this can be done in one operation, in the form of a mixture, or directly in succession. Corresponding application technologies are known to the skilled person from the prior art for the application of glass beads.

As already observed, the road marking may additionally have glass beads on the surface. This is so irrespective of whether the metal particles are present in the matrix or are also situated on the surface. If the metal particles are on the surface, they make an additional contribution to light reflection. If the metal particles are present in the matrix, the advantage of this is that they are eroded more slowly by road traffic and are therefore somewhat more long-lived. The above-recited embodiment of metal particles coated transparently with glass, PMMA or polycarbonate is very preferably applied on the surface.

Glass beads are used preferably as reflection means in formulations for trafficway markings and area markings. The commercial glass beads used have diameters of 10 μm to 2000 μm, preferably 50 μm to 800 μm. For improved processing and adhesion the glass beads may be provided with an adhesion promoter. The glass beads may preferably be silanized.

Below, by way of example, the compositions of suitable cold plastics are illustrated. The intention here is to describe in more detail only one possible embodiment, without thereby restricting the present invention to systems of this kind. As already observed, furnishing the road markings on the basis of adhesive tapes or aqueous systems, for example, with metal particles can be realized simply for the skilled person in analogy to their furnishing with glass beads.

A cold plastic of this kind is commonly prepared from a two-part reactive resin. In this case, one component contains 1.0 to 5.0 wt % of an initiator, preferably a peroxide or an azo initiator, more preferably dilauroyl peroxide and/or dibenzoyl peroxide. The other component contains 0.5 to 5.0 wt % of an accelerator, preferably a tertiary, aromatically substituted amine. One of the two components may indeed consist only of the compound or compounds stated. It is also possible for both components to otherwise have an identical composition, or for only one of the two components to comprise the fillers and/or the pigments.

The two components of the reactive resin and hence of the cold plastic formed from it preferably have in total the following further ingredients:
0.1 wt % to 18 wt % of crosslinkers, preferably di-, tri- or polyfunctional (meth)acrylates,
2 wt % to 50 wt % of monomers, preferably (meth)acrylates and/or styrene,
0 wt % to 12 wt % of urethane (meth)acrylates,
0.5 wt % to 30 wt % of prepolymers, preferably polymethacrylates and/or polyesters,
0 wt % to 15 wt % of core-shell particles, preferably based on poly(meth)acrylate,
7 wt % to 15 wt % of an inorganic pigment, preferably titanium dioxide,
30 wt % to 60 wt % of mineral fillers and
optionally further auxiliaries.

The wording “poly(meth)acrylates” encompasses not only polymethacrylates but also polyacrylates and also copolymers or mixtures of both. The wording “(meth)acrylates”, accordingly, encompasses methacrylates, acrylates or mixtures of both.

The composition of particularly suitable cold plastics and of the reactive resins that form the basis for these cold plastics may be found by reading, in particular, WO 2012/100879. Details of the further auxiliaries can also be found therein. However, the core-shell particles set out in WO 2012/100879 are not an essential feature for implementing the present invention. Instead, in particular, the proportion of the prepolymers can be higher.

The capability of the trafficway markings produced with this cold plastic to withstand wheeled traffic is particularly good. The term “capability to withstand wheeled traffic”, and the synonymously used term “back-in-service time”, mean the capacity of the trafficway marking to be subjected to load, for example to support vehicular traffic. The period required to attain capability to withstand wheeled traffic is the period from the application of the trafficway marking to the juncture at which it is no longer possible to discern any alterations in the form of abrasion, of adhesion loss to the trafficway surface or to the embedded metal particles and optional glass beads, or deformation of the marking. Dimensional stability and stability of adhesion are measured in accordance with DIN EN 1542 99 in harmony with DAfStb-RiLi 01.

In terms of the application technology, the systems of the invention can be used flexibly. The reactive resins of the invention, or cold plastics, can be applied, for example, alternatively by spraying, by pouring or by an extrusion process, or manually by means of a trowel, a roller or a doctor system.

Part of the present invention more particularly is a method for producing a road marking of the invention, characterized by the following features: first of all, if necessary, the components of the two-part system are mixed. This mixture is applied to the road surface and, during or directly after the application of the cold plastic to the trafficway surface, the metal particles and optionally glass beads are added. This is done preferably by scattering, more preferably in accelerated form.

When mixing the components it should be borne in mind that after the mixing of the hardener components, i.e. the initiators and the accelerators, the open time that remains for application is limited—from 2 to 40 minutes, for example.

Mixing in the course of processing is possible, for example, in modern marking machines which possess a mixing chamber ahead of the applicator nozzle.

Mixing in the hardener following application can be done, for example, by subsequent application with two or more nozzles, or by application of metal particles and/or glass beads that have a coating of hardener. An alternative option is to apply a primer—comprising the hardener component—by spraying before the cold plastic or cold spray plastic is applied. The modern marking machines generally possess one or two further nozzle(s) with which the metal particles and optionally the glass beads are then sprayed on.

The reactive resins of the invention and the cold plastics produced from them are used preferably for producing long-lived trafficway markings. The systems may likewise be used, more particularly in the form of an adhesive tape, with markings intended for time-limited use, as in a construction site area, for example. Their use for the coating of cycleways is additionally conceivable.

In a special embodiment of the present invention, the road markings according to the invention are applied in such a way that only regions of the road marking are provided with the metal particles. As a result, it is possible, in particular, for the road markings as such to be provided with readable information by the equipping of regions of the road marking. Thus, for example, information can be stored on the road surface in the form of a type of barcode. This information is read by vehicles equipped with a corresponding sensor. By way of example, it is possible, in this manner, to draw attention to danger spots or speed restrictions. It is also possible to support a traffic guidance system in this manner.

The examples given below are given for better illustration of the present invention, but are not such as to confine the invention to the features disclosed herein.

### EXAMPLES

The following examples have been conceived as an instruction for performing the present invention. All of these examples exhibit the same good road marking qualities as the parent formulas without metal particles. The formulations of the examples additionally exhibit good reflection of microwave radiation with a frequency between 20 and 130 GHz.

For the preparation of the examples, aluminium particles from Eisenwerk Würth GmbH with the designations Granal S-80 and Granal S-100 were used. Aluminium particles of these kinds are sold for use as blasting abrasives. The form of the particles is rounded in each case, with a non-uniform surface. The particles have the following sizes:

Granal S-80: diameter between 0.80 and 1.20 mm
Granal S-100: diameter between 1.00 and 1.80 mm

Glass beads used are surface-silanized Vialux 20 glass beads from Sovitec. These glass beads have diameters in a range between 600 and 1400 μm.

The metal particles and the glass beads (where present) are applied to the surface of the cold plastic using a pressurized gun. Alternatively, however, simple application by scattering would also be possible. That would lead to reduced, but nevertheless sufficient, adhesion.

The formula of the cold plastic used is based on the composition disclosed as Example 2 in WO 2012/100879. That example can be consulted in particular for the composition of the core-shell particles.

### Example 1

Intimately combined with 63 parts of methyl methacrylate and 5 parts of butyldiglycol dimethacrylate are 0.05 part of Topanol-O, 13 parts of DEGACRYL® M 339, 9 parts of core-shell particles and 0.5 part of paraffin, and this mixture is heated at 63° C. with vigorous stirring until all of the polymer constituents are dissolved or dispersed. For curing, 1 part of benzoyl peroxide (50 wt % strength formulation in dioctyl phthalate) and 2 parts of N,N-diisopropoxytoluidine are added and are incorporated by stirring at room temperature (21° C.) for one minute.

To effect curing, the composition was poured onto a metal plate. Within one minute after poured application, the surface is strewn with Granal S-100 particles. The amount used corresponds to 500 g of particles/m². After curing has taken place, specimens are produced in accordance with DIN 50125.

Pot life: 14 min; cure time: 30 min; flow time (4 mm): 252 sec

### Example 2

The operating principle of a radar sensor consists of emitting microwaves, which are reflected on objects. This returning radar wave is subsequently detected at the sensor. The distance to the object is determined by the time difference between emitting and receiving the signal.

The radar reflectivity of objects is usually quantified by the radar cross section (RCS). This is particularly expedient if this is a punctiform object. Punctiform objects reflect the arriving radar wave such that a single echo is measurable at the receiver. However, if the object has an elongate reflection surface in the propagation direction, the returning echo of the radar waves is extended in time at the receiver. Precisely this phenomenon is present in the case of the road marking. It is therefore no longer possible to determine an RCS (σ) of the road marking in any meaningful manner. Rather, an RCS per unit length of the road marking is determined (Δσ/Δl). Here, σ is the RCS and l is the length of the road marking in the propagation direction of the outward radar wave.

A measurement is now carried out to determine quantitative radar reflectivity of the road marking Δσ/Δl. To this end, a pattern of the road marking is produced as described in Example 1. A Plexiglas® plate with a width of 0.20 m and a length of 2 m is used as a base instead of a metal sheet. The marking applied thereon has a width w and likewise a length of 2 m.

This test marking is installed on a flat surface and in surroundings that absorb EM waves. A radar sensor operating in the frequency band from 76 to 77 GHz is installed away from the marking at a horizontal distance lₘᵢₙ. The radar sensor is aligned in such a way that the main radar lobe forms a line with the longitudinal direction of the road marking. The radar sensor has a height hₛₑₙₛₒᵣ above the plane in which the road marking is situated.

For this trial assembly, the target variable to be measured can be calculated theoretically as:

$$\frac{Δσ}{Δ l} = w \cdot μ \cdot d \cdot \frac{{h}_{sensor}}{\sqrt{{h}_{sensor}^{2} + {l}^{2}}}$$

Here, μ is the amplification factor of the reflection on the aluminium particles caused by Mie scattering compared to the optical reflection. The attenuation factor d takes account of the fact that the surface of the marking is not wholly populated with aluminium particles. If only 10% of the marking surface is populated by aluminium particles, d=0.1 applies. For spherical particles, the attenuation factor d can be calculated theoretically:

$$d = \frac{3 \cdot m \text{/} A}{4 \cdot ρ \cdot r}$$

Here, m/A is the mass of the particles per unit area which is distributed on the marking. In Example 1, this is 500 g/m². ρ is the density of the particles. For the utilized aluminium particles, ρ=2700 kg/m³ applies. r is the radius of the spherical particles. For Granal S-100, a mean radius of r=0.7 mm is assumed.

A theoretical attenuation factor d=0.198≈20% is obtained with these parameters.

With the parameters:

lₘᵢₙ=1 m
l=2 m
hₛₑₙₛₒᵣ=0.5 m
w=0.15 m
μ=3 (as average, since the sphere sizes do not only correspond to the maximum of the Mie scattering at μ=3.75),
an RCS per unit length of

$$\frac{Δσ}{Δ l} = w \cdot μ \cdot d \cdot \frac{{h}_{sensor}}{\sqrt{{h}_{sensor}^{2} + {l}^{2}}} = 0.0218 m$$

is obtained for the theoretical Δσ/Δl.

In practical trials, Δσ/Δl=0.0314 m was measured. The greater practical value can be explained by virtue of the fact that the radar lobe is not perpendicular to the plane of the marking. As a result of the oblique viewing angle of the radar sensor on the marking, the theoretically calculated d is significantly larger, and so Δσ/Δl is as well.

### Example 3

The marking is produced as in Example 1. The measurement is carried out as in Example 2, but using a radar sensor with the frequency band from 77 to 81 GHz instead of a radar sensor with 76/77 GHz. The measurement result obtained here is Δσ/Δl=0.0338 m. The relatively small change in frequency also results in a relatively small change in the radar reflectivity.

### Example 4

Like Example 1, but using the material Granal S-80 instead of Granal S-100 particles. The procedure of Example 2 is adopted for measuring the radar reflectivity Δσ/Δl. The result of the measurement is Δσ/Δl=0.0156 m. The significantly reduced radar reflectivity can be explained by virtue of the fact that the particle diameter no longer corresponds to the optimum of d=1.25 mm.

### Example 5

Like Example 1, but using cylindrical particles of aluminium as material instead of Granal S-100. The length of the cylinder lies between 1.7 and 2.2 mm. The thickness of the particles is 0.2 mm. 100 g particles per m² are scattered onto the marking. The measurement is carried out as in Example 2. The result of the measurement is Δσ/Δl=0.0121 m.

### Example 6

Like Example 1, but with additional scattered application, from a pre-prepared mixture with the Granal S-100 particles, of glass beads, in an amount corresponding to 280 g/m².

### Example 7

Like Example 3, but with the Granal S-100 particles being incorporated into the composition by stirring together with the core-shell particles, and with scattering of glass beads only following poured application.

### Comparative Example

Like Example 6, but without aluminium particles.

1. A radiation-reflecting road marking comprising:
spherical metal particles having a diameter d of between x*0.7*λ/π and x*1.3*λ/π and/or
cylindrical metal particles having a length/width ratio between 2 and 100 and a length 1 between y*λ/1.8 and y*λ/3, λ being the wavelength of the radiation to be reflected, x being an integer between 1 and 6 and y being an integer between 1 and 20.

2. The radiation-reflecting road marking according to claim 1,
wherein the metal particles are particles consisting wholly or partly of aluminium, iron, magnesium or zinc or of an alloy predominantly containing aluminium, iron, magnesium or zinc.

3. The radiation-reflecting road marking according to claim 1,
wherein the metal particles consist wholly of the metal, the surface is coated with the metal, or the metal is coated with glass, PMMA or polycarbonate.

4. The radiation-reflecting road marking according to claim 1,
wherein the cylindrical metal particles have a length/width ratio between 5 and 20 and y is an integer between 1 and 4.

5. The radiation-reflecting road marking according to claim 1,
wherein the matrix material of the road marking comprises an adhesion promoter and/or the metal particles are provided on the surface with an adhesion promoter, and
wherein the adhesion promoter is at least one adhesion promoter selected from the group of silanes, hydroxyesters, aminoesters, urethanes, isocyanates and/or acids copolymerizable with (meth)acrylates.

6. The radiation-reflecting road marking according to claim 1,
wherein the road marking is a prefabricated adhesive tape or a water-based paint.

7. The radiation-reflecting road marking according to claim 1,
wherein the road marking is a cold plastic.

8. The radiation-reflecting road marking according to claim 1,
wherein the road marking additionally has glass beads on the surface.

9. The radiation-reflecting road marking according to claim 1,
wherein the metal particles are situated on the surface of the road marking.

10. The radiation-reflecting road marking according to claim 7,
wherein the cold plastic has been produced from a two-part reactive resin in which one component comprises 1.0 to 5.0 wt % of an initiator, preferably dilauroyl peroxide and/or dibenzoyl peroxide, and the other component comprises 0.5 to 5.0 wt % of an accelerator, preferably a tertiary, aromatically substituted amine, and in that the reactive resin in total further comprises:
0.1 wt % to 18 wt % of crosslinkers,
2 wt % to 50 wt % of monomers,
0 wt % to 12 wt % of urethane (meth)acrylates,
0.5 wt % to 30 wt % of prepolymers,
0 wt % to 15 wt % of core-shell particles,
7 wt % to 15 wt % of an inorganic pigment, preferably titanium dioxide,
30 wt % to 60 wt % of mineral fillers, and
optionally further auxiliaries.

11. The radiation-reflecting road marking according to claim 1,
wherein the frequency of the electromagnetic radiation to be reflected lies between 20 and 130 GHz.

12. The radiation-reflecting road marking according to claim 11, wherein the frequency lies between 76 and 81 GHz.

13. The radiation-reflecting road marking according to claim 1,
wherein only regions of the road marking are provided with the metal particles.

14. The radiation-reflecting road marking according to claim 13, wherein by equipping regions of the road marking, these are provided with readable information.

15. A method for producing a road marking according to claim 7, wherein, where necessary, two-part systems are mixed, the mixture is applied to the road surface and the metal particles and optionally glass beads are added during or directly after the application of the cold plastic to the trafficway surface.

16. A composition comprising:
spherical metal particles having a diameter d of between x*0.7*λ/π and x*1.3*λ/π and/or
cylindrical metal particles having a length/width ratio between 2 and 100 and a
length 1 between y*λ/1.8 and y*λ/3, λ being the wavelength of the radiation to be reflected, x being an integer between 1 and 6 and y being an integer between 1 and 20.

17. The composition of claim 16 that is not cured.

18. The composition of claim 16 that has been cured.

19. A system comprising the composition of claim 16 in a form that reflects radiation, a radar emitter and sensor.
